(19) United States
(12) Patent Application Publication
(10) Pub. No.: US 2024/0011477 A1
(43) Pub. Date: Jan. 11, 2024

(54) PUMP MOTOR PREDICTIVE MAINTENANCE

(71) Applicant: NORDSON CORPORATION, WESTLAKE, OH (US)

(72) Inventor: Laurence B. SAIDMAN, Duluth, GA (US)

(73) Assignee: NORDSON CORPORATION, WESTLAKE, OH (US)

(21) Appl. No.: 18/247,291

(22) PCT Filed: Sep. 15, 2021
(86) PCT No.: PCT/US2021/050380

§ 371 Date: Mar. 30, 2023

Related U.S. Application Data
(60) Provisional application No. 63/087,963, filed on Oct. 6, 2020.

(51) Int. Cl. F04B 49/06; F04B 23/04; F04C 11/00; B05C 11/10; B05C 5/02

(52) U.S. Cl. CPC F04B 49/065; F04B 23/04; F04C 11/001; B05C 11/1044; B05C 5/0258

(57) ABSTRACT

In one example, an application system has a material supply system, a plurality of dispensers, a plurality of pumps, and a controller. The supply system can supply the liquified material to the pumps. The pumps can pump the liquified material to the plurality of dispensers, and the dispensers can dispense the liquified material onto a substrate. The controller can receive, for the pumps, measures of electrical current drawn by the pumps. The controller can determine an average electrical current by averaging the measures of the electrical current drawn by the pumps. The controller can generate, for each of one or more of the pumps, a metric based on the average current, wherein the metric is indicative of how soon the pump is likely to fail. Maintenance and/or replacement of the pump can then be scheduled based on the metric.

### CROSS REFERENCE TO RELATED APPLICATIONS

This application is a National Stage Application of International Patent App. No. PCT/US2021/050380, filed Sep. 15, 2021, which claims the benefit of U.S. Provisional Patent App. No. 63/087,963, filed Oct. 6, 2020, the entire disclosures of both of which are hereby incorporated by reference as if set forth in their entirety herein.

### TECHNICAL FIELD

This application relates to methods and systems for applying a liquified material to a substrate using one or more pumps, and more specifically to predicting potential failures in such systems associated with the pumps before the failures occur.

### BACKGROUND

Typical liquid material application systems for applying material to a substrate include a storage device that provides a supply of liquified material to any number of dispensers, each of which are capable of applying the liquified material to a substrate. However, the storage device and applicators can be spaced apart, which causes the liquified material to travel a distance between the storage device and the applicators. Thus, liquid material application systems commonly employ pumps to pump the liquified material from the storage device to the applicators.

### SUMMARY

One example is a method of operating an application system that is configured to apply a liquified material to a substrate. The method comprises operating a plurality of pumps of the application system to supply a liquified material from a material supply system of the application system to a plurality of dispensers of the application system. The method comprises receiving, for each of the plurality of pumps, a measure of electrical current drawing by the pump. The method comprises determining an average electrical current for the plurality of pumps by averaging the measures of the electrical current drawn by the plurality of pumps. The method comprises generating, for each of one or more of the plurality of pumps, a metric based on the average current, wherein the metric is indicative of how soon the pump is likely to fail.

In another example, an application system is configured to apply a liquified material to a substrate. The application system comprises a material supply system, a plurality of dispensers, a plurality of pumps, and a controller. The material supply system is configured to supply the liquified material. The plurality of dispensers is configured to receive the liquified material and dispense the liquified material onto a substrate. The plurality of pumps is in fluid communication with the material supply system and configured to pump the liquified material to the plurality of dispensers. The controller is configured receive, for each of the plurality of pumps, a measure of electrical current drawn by the pump. The controller is configured to determine an average electrical current by averaging the measures of the electrical current drawn by the plurality of pumps. The controller is configured to generate, for each of one or more of the plurality of pumps, a metric based on the average current, wherein the metric is indicative of how soon the pump is likely to fail.

Another example is a non-transitory, computer-readable storage medium storing instructions thereon. When executed by a computer, the instructions cause the computer to receive, for each of a plurality of pumps of an application system, a measure of electrical current drawn by the pump, while the plurality of pumps supply a liquified material from a material supply system of the application system to a plurality of dispensers of the application system. The instructions cause the computer to determine an average electrical current for the plurality of pumps by averaging the measures of the electrical current drawn by the plurality of pumps. The instructions cause the computer to generate, for each of one or more of the plurality of pumps, a metric based on the average current, wherein the metric is indicative of how soon the pump is likely to fail.

### BRIEF DESCRIPTION OF THE DRAWINGS

The following description of the illustrative examples may be better understood when read in conjunction with the appended drawings. It is understood that potential examples of the disclosed systems and methods are not limited to those depicted.

FIG. 1 shows a simplified schematic diagram of an application system according to one example;

FIG. 2 shows a simplified schematic diagram of an application system according to another example;

FIG. 3 shows a simplified flow diagram of a method of operating an application according to one example to detect how soon a pump of the application system is likely to fail;

FIG. 4 shows a simplified flow diagram of one example of a method that may be used to implement step 208 of FIG. 3 to generate the metrics;

FIG. 5 shows a simplified flow diagram of another example of a method that may be used to implement step 208 of FIG. 3 to generate the metrics;

FIG. 6 shows a simplified flow diagram of yet another example of a method that may be used to implement step 208 of FIG. 3 to generate the metrics;

FIG. 7 shows a table of data generated during a simulation for an application system having six pumps;

FIG. 8 shows an example plot generated for the six pumps in the simulation of FIG. 7, where measured electrical current is shown on the y-axis, average current is shown on the x-axis, and each line corresponds to a different pump;

FIG. 9 shows an example plot generated of metrics over time for the six pumps in the simulation of FIG. 7, where the metrics are shown on the y-axis and time is shown on the x-axis; and

FIG. 10 shows an example plot generated of filtered metrics over time for the six pumps in the simulation of FIG. 7, where the filtered metrics are shown on the y-axis and time is shown on the x-axis.

### DETAILED DESCRIPTION

In application systems that employ pumps, such as those discussed above, failures associated with the pumps can occur over time. Often, these failures can be manifested by a rise in the electrical current drawn by the motors of the pumps. For example, and without being bound by theory, it is believed that a breakdown of the grease in the transmission of a gear pump due to, for example, overheating of the gears, can result in inadequate lubrication of the gears. This in turn can increase the friction within the gears. To compensate for the increased friction, the amount of electrical current drawn by the pump motor is increased. In some cases, if this issue is not addressed, then continued operation of the pump motor at elevated current draws can cause the motor to eventually fail. It is believed that other failure modes associated with gear pumps and other types of pumps can similarly be manifested by a rise in the electrical current drawn by the motors of the pumps. The failure can be a failure of the motor of the pump or of another component. If a pump fails during a production cycle, then the application system or portions thereof may need to be shut down to repair or replace the pump, thereby causing unwanted production delays. If, on the other hand, the issue is addressed (e.g., lubrication is added to the gears), then it is possible that a life of the pump could be extended.

The present disclosure relates to the operation of liquid material application systems that are configured to dispense a liquified material to a substrate. In general, a liquid material application system of the present disclosure comprises a material supply system, a plurality of dispensers that are configured to dispense the liquified material to a substrate, and a plurality of pumps that are configured to pump the liquified material from the material supply system to the plurality of dispensers. A controller is configured to generate a metric, for each of one or more of the plurality of pumps, based on an average electrical current for the plurality of pumps. Each metric is indicative of how close a corresponding pump is to failing. The metrics can then be used to schedule maintenance or replacement of one or more of the pumps prior to the one or more of the pumps failing. Preferably, the maintenance or replacement can be scheduled during an upcoming, pre-planned shutdown of the application system. Scheduling pump replacement and/or maintenance in such a manner can avoid unscheduled shutdowns of the application system, which would otherwise cause production delays.

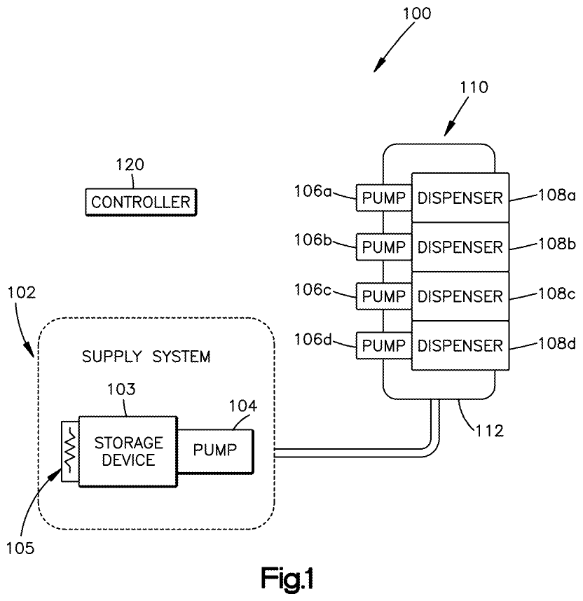

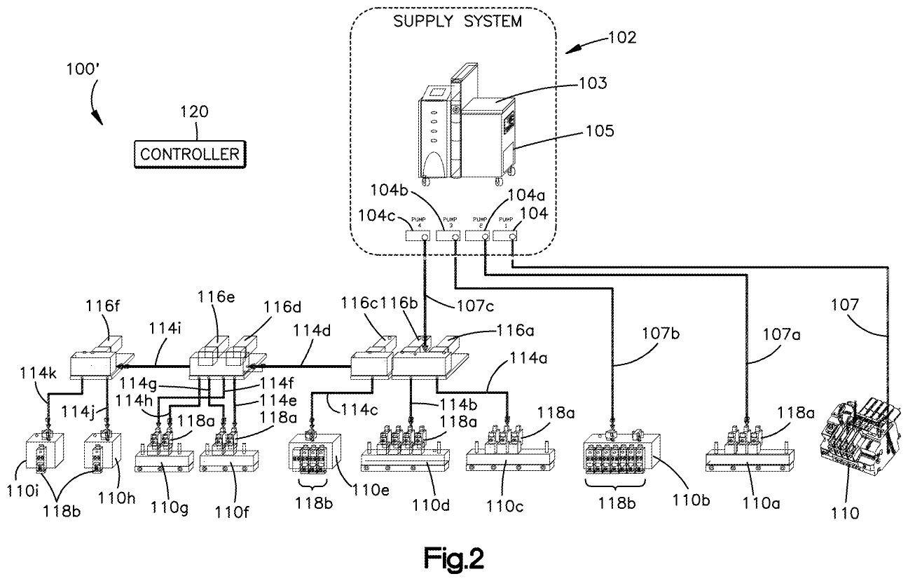

For ease of discussion, the operation of two exemplary application systems 100 and 100′ in FIGS. 1 and 2, respectively, will be described. However, it will be understood that application systems having configurations other than those shown in FIGS. 1 and 2 can be operated in the manner consistent with that described herein. Therefore, the following discussion of FIGS. 1 and 2 is for illustrative purposes and is not meant to limit the present invention to only the configurations of applications systems shown in FIGS. 1 and 2.

In each exemplary application system 100 and 100′, a single material supply system 102 supplies a liquified material to a plurality of pumps of the system. During the operation of each system 100 and 100′, a viscosity of the liquified material can change due to, for example, (i) variations in the composition of the liquified material from one batch of the liquified material to another and/or (ii) changes in temperature of the liquified material. Since the liquified material is supplied by a single material supply system 102, the change in viscosity of the liquified material will typically be experienced equally by each of the plurality of pumps. As the viscosity of the liquified material changes, the load requirements of the pumps can correspondingly change. Since each pump experiences the same change in viscosity of the liquified material, the change in load requirements will tend to be the same from one pump to the next.

In addition, in each system 100 and 100′, the flow rates of each of the plurality of pumps is a ratio to a speed line signal of a single master supply line that supplies the liquefied material from the single material supply system 102. As demand for the liquified material increases or decreases, the line speed of the single master supply line correspondingly changes. As a result, each of the pumps will tend to experience the same changes in load due to increasing or decreasing fluid demand.

Referring more specifically to FIG. 1, a simplified schematic diagram of a first illustrative application system 100 is shown that comprises (1) a material supply system 102, (2) a plurality of pumps 106a to 106d, (3) a plurality of dispensers 108a to 108d, and (4) a controller 120. In this example, a single fluid supply path 107 extends from the supply system 102 to provide liquified material towards the dispensers 108a to 108d. It will be understood that application systems of the disclosure can have one or more supply paths that extend from the supply system 102. FIG. 2, discussed below, shows an illustrative application system 100′ with more than one supply path.

The material supply system 102 is configured to supply the liquified material to the dispensers 108a to 108d. The material supply system 102 can have a storage device 103 for storing a supply of the material to be dispensed by the dispensers 108a to 108d. The storage device 103 can be a tank, a remote hopper, such as a bin, or any other suitable storage container for storing the material. In some examples, the material supply system 102 can be a melter that comprises the storage device 103 and a heater 105. In other examples, the supply system 102 can comprise a separate storage device 103, such as a hopper, that is configured to feed the material to a separate melter of the supply system 102. The material supply system 102 can be configured to receive the material in solid form (e.g., as a block or particulate) or semi-solid form and heat the material to liquify the material. The material can be an adhesive such as a hot-melt adhesive. Alternatively, the material can be other heated or unheated materials such as lotions, fragrances, and odor control products.

The material supply system 102 can optionally include a supply pump 104 that is configured to feed the material from the storage device 103 towards the plurality of dispensers 108a to 108d. In some examples, the supply pump 104 can be a conventional gear pump having a dedicated drive motor for driving gears of the gear pump, though other types of pumps are contemplated, such as gerotor or piston pumps. In other examples, the material supply system 102 can be devoid of a supply pump 104, and the liquified material can instead be fed from the storage device 103 by pressure to a plurality of downstream pumps such as pumps 106a to 106d.

The application system 100 comprises a fluid supply path 107 that extends from the supply system 102 to provide the liquified material towards the plurality of dispensers 108a to 108d. The fluid supply path 107 can be a conduit that transfers the liquified material from the material supply system 102. The conduit can comprise, for example, a hose, pipe, or a combination thereof. Although not shown, the fluid supply path 107 can comprise conduit fittings, such as pipe and/or hose fittings. The conduit 107 can fluidly connect the material supply system 102 to the plurality of pumps 106a to 106d, such that the fluid supply path 107 is devoid of any intervening pumps between the material supply system 102 and the plurality of pumps 106a to 106d. For instance, the fluid supply path 107 can be devoid of any intervening pumps between the supply pump 104 and the plurality of pumps 106a to 106d.

The plurality of pumps 104 and 106a to 106d are in fluid communication with the material supply system 102. The pumps 106a to 106d can be the same size and type, or the size and/or types of one or more of the pumps 106a to 106d can vary from that of one or more other pumps. In one example, the pumps 106a to 106d can be gear flow pumps, although each pump 106a to 106d can be any other suitable type of pump. Each pump 106a to 106d is configured to pump the fluid material to at least one of the dispensers 108a to 108d. In one example, each pump 106a to 106d can be configured to pump the fluid material to a different one of the dispensers 108a to 108d.

Each dispenser 108a to 108d is configured to receive fluid material from a pump 106a to 106d and dispense the fluid material onto a substrate. The dispensers 108a to 108d can be the same size and type, or the size and/or type of one or more of the dispensers 108a to 108d can vary from that of one or more other dispensers. Each dispenser 108a to 108d can comprise components for dispensing the liquified material, such as a valve that controls the flow of the liquified material from the dispenser, a nozzle, or both a valve and a nozzle. Each valve can be a mechanical valve, an electro-mechanical valve, a solenoid valve, a pneumatic valve, or other suitable valve.

In the example of FIG. 1, the application system 100 comprises an applicator 110 that comprises a manifold 112, the plurality of pumps 106a to 106d, and the plurality of dispensers 108a to 108d. Although five pumps and five dispensers are shown, it will be understood that applicators of the disclosure can have at least two pumps and at least two dispensers. One or more of the pumps 106a to 106d can be mounted onto the manifold 112. Additionally, or alternatively, one or more of the dispensers 108a to 108d can be mounted onto the manifold 112. The manifold 112 can be configured to receive the fluid material from the material supply system 102 and distribute the fluid material to the plurality of pumps 106a to 106d. The manifold 112 can define at least one fluid passage, such as a plurality of fluid passages, therein that is configured to distribute the fluid from the material supply system 102 to the plurality of pumps 106a to 106d. It will be understood that, in alternative examples, the application system 100 can be devoid of the manifold 110, and the material supply system 102 can supply the liquified material directly to the pumps 106a to 106d without passing the liquified material through a manifold.

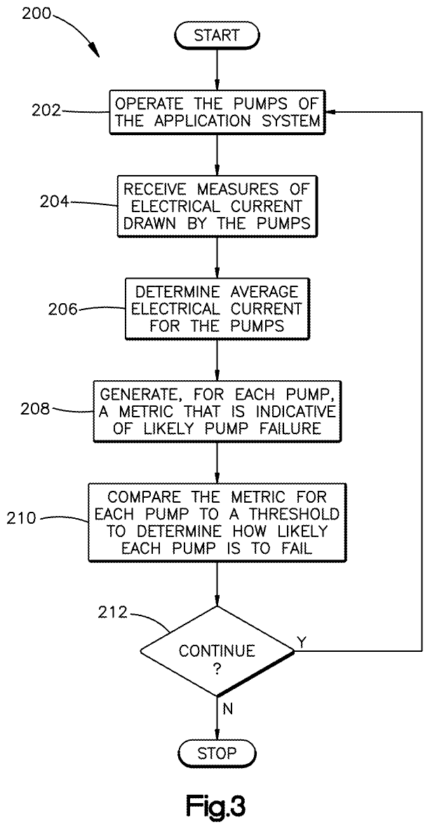

The controller 120 can comprise any suitable computing device configured to execute a software application for monitoring and controlling various operations of the application system 100 as described herein. The controller 120 can be configured to generate, for each of one or more of the plurality of pumps 104 and 106a to 106d, a metric based on an average current for the plurality of pumps 104 and 106a to 106d, wherein the metric is indicative of how likely the pump is to fail or how close the pump is to failing. Generation of the metrics will be described in further detail below in relation to FIG. 3.

It will be understood that the controller 120 can be a processor, a desktop computing device, a server computing device, or a portable computing device, such as a laptop, tablet, or smart phone. The controller 120 can include a memory (not shown) and a Human Machine Interfaces (HMI) (not shown). The memory can be volatile (such as some types of RAM), non-volatile (such as ROM, flash memory, etc.), or a combination thereof. The controller 120 can include additional storage (e.g., removable storage and/or non-removable storage) including, but not limited to, flash memory, smart cards, CD-ROM, digital versatile disks (DVD) or other optical storage, magnetic tape, magnetic disk storage or other magnetic storage devices, universal serial bus (USB) compatible memory, or any other medium which can be used to store information and which can be accessed by the controller 120. The HMI device can include inputs that provide the ability to interact with the controller 120, via, for example, buttons, soft keys, a mouse, voice actuated controls, a touch screen, movement of the controller 120, visual cues (e.g., moving a hand in front of a camera on the controller 120), or the like. The HMI device can provide outputs via a graphical user interface, including visual information, such as the visual indication of current flow characteristics of various portions of the application system 100, as well as acceptable ranges for these parameters via a display. Other outputs can include audio information (e.g., via a speaker), mechanically (e.g., via a vibrating mechanism), visual (e.g., via a light tower), or a combination thereof. In various configurations, the HMI device can include a display, a touch screen, a keyboard, a mouse, a motion detector, a speaker, a microphone, a camera, or any combination thereof. The HMI device can further include any suitable device for inputting biometric information, such as, for example, fingerprint information, retinal information, voice information, and/or facial characteristic information, for instance, so as to require specific biometric information for accessing the controller 120. The controller 120 can yet further comprise any suitable device for communicating signals, such as a transmitter.

Turning now to FIG. 2, in a second example, an application system 100′ comprises (1) a material supply system 102, (2) a plurality of pumps, (3) a plurality of dispensers, and (4) a controller 120. The controller 120 can be configured as discussed above in relation to FIG. 1. In this example, a plurality of supply paths 107, 107a, 107b, and 107c extend from the material supply system 102 to provide liquified material towards the dispensers. The material supply system 102 is configured to supply the liquified material to the dispensers, and can be configured in any suitable manner as discussed above in relation to FIG. 1.

The material supply system 102 can optionally include a plurality of supply pumps 104, 104a, 104b, and 104c that are configured to feed the material from the storage device 103 of the material supply system 102 towards the plurality of dispensers. In some examples, each supply pump 104, 104a, 104b, and 104c can be a conventional gear pump having a dedicated drive motor for driving gears of the gear pump, though other types of pumps are contemplated, such as gerotor or piston pumps. In other examples, the material supply system 102 can be devoid of supply pumps 104, and the liquified material can instead be fed from the storage device 103 by pressure to a plurality of downstream pumps.

The plurality of fluid supply paths 107, 107a, 107b, 107c that extend from the material supply system 102 to provide the liquified material towards the plurality of dispensers. Each fluid supply path 107, 107a, 107b, 107c can be a conduit that is configured as described above in relation to fluid supply path 107 of FIG. 1 and can be configured to transfer the liquified material from the material supply system 102. In FIG. 2, four fluid supply paths 107, 107a, 107b, 107c are shown. However, it will be understood that, in alternative examples, application systems of the disclosure can be implemented with one or more supply paths.

Each fluid supply path 107, 107a, 107b, 107c provides the liquid material to a corresponding at least one dispenser. For example, the application system 100′ can comprise at least one fluid supply path 107, where each is configured to provide the fluid material to an applicator 110 that is configured as discussed above in relation to FIG. 1 (i.e., comprising a manifold 112, the plurality of pumps 106a to 106d, and the plurality of dispensers 108a to 108d).

Additionally, or alternatively, the application system 100′ can comprise at least one fluid supply path, where each is configured to supply the fluid material to at least one applicator, without supplying the fluid material to any pumps downstream of the material supply system 102. In other words, both the fluid supply path and the at least one applicator can be devoid of any pumps. FIG. 2 shows examples of two such flow paths 107a and 107b. In particular, FIG. 2 shows a fluid supply path 107a that is configured to supply the fluid material to an applicator 110a, without supplying the fluid material to any pumps downstream of the material supply system 102. Thus, both the fluid supply path 107a and the applicator 110a are be devoid of any pumps.

The applicator 110a can be configured as a slot applicator that dispenses the liquified material onto the substrate through an elongate outlet slot. However, it will be understood that the applicator 110a can be any other suitable applicator. The slot applicator 110a can comprise at least one dispenser 118a, such as a plurality of dispensers 118a. In FIG. 2, the applicator 110a comprises three dispensers 118a. However, it will be understood that the slot applicator 110a can comprise any suitable number of dispensers 118a, such as one or more of such dispensers. Each dispenser 118a can be implemented as a valve, such as a mechanical valve, an electro-mechanical valve, a solenoid valve, a pneumatic valve, or other suitable valve.

FIG. 2 also shows a fluid supply path 107b that is configured to supply the fluid material to an applicator 110b, without supplying the fluid material to any pumps downstream of the material supply system 102. Thus, both the fluid supply path 107b and the applicator 110b are be devoid of any pumps. The applicator 110b can be configured as a spray applicator that comprises at least one dispenser, such as a plurality of dispensers 118b, that are configured to spray the liquified material onto a substrate. In FIG. 2, the spray applicator 110b comprises a manifold, and seven of dispensers 118b mounted thereto, where the manifold defines at least one internal channel therein that distributes the liquified material to the dispensers 118b. Each dispenser 118b can be implemented as a valve, such as a mechanical valve, an electro-mechanical valve, a solenoid valve, a pneumatic valve, or other suitable valve. It will be understood that, in alternative examples, the applicator 110b can be any other suitable applicator, and the applicator 110b can have any suitable number of dispensers, such as one or more dispensers.

Additionally, or alternatively, the application system 100′ can comprise at least one fluid supply path 107c, each being configured to supply the liquified material to at least one dispenser 118a, 118b via at least one downstream pump 116a to 116f and at least one downstream fluid path 114a to 114i. Thus, in some examples, the application system 100′ can comprise at least one downstream pump and at least one downstream fluid path that fluidly connects the upstream supply path 107c to at least one dispenser. Each downstream pump 116a to 116f can be a conventional gear pump having a dedicated drive motor for driving gears of the gear pump, though other types of pumps are contemplated, such as gerotor or piston pumps. The downstream pumps 116a to 116f can be the same size and type, or the size and/or types of one or more of the downstream pumps 116a to 116f can vary from that of one or more other pumps. Each downstream pump 116a to 116f can be part of a metering station that includes the pump and a manifold that is configured to divide the liquified material that it receives into two or more downstream fluid paths 114a to 114i. Each downstream fluid path 114a to 114i can be a conduit that transfers the liquified material. The conduit can comprise, for example, a hose, pipe, or a combination thereof. Although not shown, the downstream fluid paths can comprise conduit fittings, such as pipe and/or hose fittings.

Each downstream pump 116a to 116f can be configured to pump the liquified material to 1) at least one dispenser 118a, 118b, 2) at least one other downstream pump 116d to 116f, or 3) at least one dispenser and at least one other downstream pump. For example, in FIG. 2, the fluid supply path 107c supplies the liquified material to three downstream pumps 116a to 116c. However, it will be understood that, in alternative examples, the fluid supply path 107c can supply the liquified material to any suitable number of downstream pumps, such as one or more downstream pumps. The downstream pumps 116a and 116b are in fluid communication with, and hence configured to pump the liquefied material to, applicators 110c and 110d, respectively. The applicators 110c and 110d can be implemented as slot applicators in a manner similar to that discussed above in relation to slot applicator 110a. However, it will be understood that the applicators 110c and 110d can be any other suitable applicators.

The downstream pump 116c is in fluid communication with, and hence configured to pump the liquified material to, 1) the dispensers 118b of an applicator 110e via downstream fluid path 114c and 2) downstream pumps 116d and 116e via downstream fluid path 114d. The applicator 110e can be configured as a spray applicator in a manner similar to that discussed above in relation to applicator 110b. However, it will be understood that, in alternative examples, the applicator 110e can be any other suitable applicator.

The downstream pump 116d is configured to pump the liquified material to 1) at least one dispenser 118a of applicator 110f via downstream fluid path 114e, and 2) at least one dispenser 118a of applicator 110g via downstream fluid path 114f. The downstream pump 116e is configured to pump the liquified material to 1) at least one dispenser 118a of applicator 110f via downstream fluid path 114g, 2) at least one dispenser 118a of applicator 110g via downstream fluid path 114h, and 3) the downstream pump 116f via downstream fluid path 114i The applicators 110f and 110g can be configured as a slot applicator in a manner similar to that discussed above in relation to applicator 110a. However, it will be understood that, in alternative examples, the applicators 110f and 110g can be any other suitable applicator.

The downstream pump 116f is configured to pump the liquified material to 1) at least one dispenser 118b of applicator 110h via downstream fluid path 114j, and 2) at least one dispenser 118b of applicator 110i via downstream fluid path 114k. The applicators 110h and 110i can be configured as a spray applicators in a manner similar to that discussed above in relation to applicator 110b. However, it will be understood that, in alternative examples, the applicators 110h and 110i can be any other suitable applicator.

Turning to FIG. 3, a simplified flow diagram is shown of a method 200 of operating an application system to generate metrics for determining impending pump failures. The method 200 can be implemented by the application system 100 of FIG. 1, the application system 100′ of FIG. 2, or any other suitable application system comprising a plurality of pumps. The method 200 comprises, in step 202, operating the plurality of pumps (e.g., 104, 104a to 104c, 106a to 106d, 116a to 1160 of the application system to supply a liquified material from a material supply system (e.g., 102) of the application system to a plurality of dispensers (e.g., 108a to 108d, 118a, 118b) of the application system. The method comprises, in step 204, receiving, for each of the plurality of pumps, a measure of electrical current drawn by the pump. The measure of the electrical current drawn by each pump can be received by a controller (e.g., 120) of the application system. In some examples, step 204 can be performed for a plurality of time periods to collect a plurality of measures of electrical current for each pump. This early data can be used to generate the metrics as will be described below.

In step 206, the method comprises a step of determining an average electrical current for the plurality of pumps. In step 208, the method comprises generating, for each of one or more of the plurality of pumps, a metric based on the average current, wherein the metric is indicative of how soon the pump is likely to fail. The metrics can be generated in any suitable manner. For example, step 208 can comprise (1) a step of determining, for each of one or more of the plurality of pumps, a predicted electrical current drawn by the pump at a given period of time based on the average electrical current at that time, and (2) a step of determining, for each of one or more of the plurality of pumps, the metric for the pump at the given period of time based on (i) the predicted electrical current for the pump at the given period of time and (ii) the measure of electrical current drawn by the pump at the given period of time. Three exemplary methods of generating the metrics are described below in relation to FIGS. 4 to 6. After generating the metric for each of one or more of the plurality of pumps, the metric can be compared to a threshold in step 210 to determine how soon the pump likely is to fail. An estimate of when each pump is likely to fail can be determined from its corresponding metric or based on its corresponding metric. The estimate can be expressed as a percentage (e.g., 20% life remaining), as a run-time life remaining until pump failure (e.g., 100 hours), or in any other suitable manner of expressing a remaining life of a pump until pump failure. Method 200 can then be repeated one or more times (e.g., at step 212) to generate, for each one or more of the plurality of pumps, a metric for each period of time based on the average electrical current corresponding to the period of time. Thus, step 208 can be repeated to generate a plurality of metrics for each pump, where the metrics for each pump correspond to different periods of time.

Although not shown, the method can comprise a step of generating, based on the comparisons of step 210, a notification to a user when a metric indicates an approaching pump failure. The notification can be, for example, an audible notification, a visual notification on a monitor or by a light, or any other suitable notification or combination of notifications. The notification can be indicative of the particular pump that is likely to fail. The notification can be generated by a controller, such as controller 120. The method can comprise a step of transmitting, based on the comparisons of step 210, a signal that is indicative of a need for servicing at least one of the pumps or that schedules service for at least one of the pumps. For example, the signal can be transmitted to an overall system control for a product manufacturing line, where the product manufacturing line includes the application system 100 or 100′ and one or more other product processing devices. As another example, the signal can be transmitted to a service provider, such as a computing system of a service provider, so that the service provided can schedule the service and/or perform the service. The signal can be transmitted to another system that handles one or more, up to all, of inventory management, purchasing, and scheduling maintenance. The system can be configured to take actions to enable preventative maintenance of the pumps. The signal can be transmitted by, for example, a transmitter of a controller such as controller 120. The signal can be transmitted over a wired communications channel, a wireless communications channel, or a combination of wired and wireless communications channels. In some examples, the signal can be transmitted over a network or over the internet.

In the example of FIG. 3, a failure prediction is made for each specific pump based on a corresponding metric or corresponding metrics generated for that same pump. In some examples, a failure prediction can be made for one or more pumps based on failure predictions made for one or more other pumps in (1) the same application system, (2) in one or more other application systems, or (3) in both the same application system and one or more other application systems. In some instances, the one or more other pumps could be replacement pumps that replace the pumps for which the metrics were generated. In some examples, a computing system can store information relating to predicted failures of pumps of one or more application systems (e.g., one or more systems 100). The computing system can then use that stored information to predict failures of one or more other pumps in one or more application systems. In one example, the stored information can comprise a measurement of time from the initial startup of each pump to a predicted failure of the pump. The measurement of time can be a measurement of actual use (e.g., operational hours) of each pump until a predicted failure. In another example, the stored information can additionally or alternatively comprise total rotations of the pump. This information can then be used to predict when other pumps in the same application system and/or in different application systems might fail. Further, this information can be used in addition to, or alternatively to, the metric-based predictions generated for each specific pump according to the method of FIG. 3.

Over time, the computing system can construct a statistical distribution of total operational time until predicted failure, such as a Weibull B 10 plot or other suitable failure distribution. Then, the failure predictions generated based on the statistical distribution can be used in addition to, or alternatively to, the metric-based failure predictions generated according to the method of FIG. 3. The failure predictions generated based on the statistical distribution can be used to plan maintenance further in advance of receiving the metric-based failure predictions, or can improve system reliability by servicing some pumps that have more than expected hours of life rather than waiting for a metric-based failure prediction that could turn out to be anomalous. Constructing the statistical distribution based on predicted failures, rather than actual failures, can avoid the downtime costs that would otherwise result from waiting for pumps to actually fail.

In some examples, the method can comprise the scheduling maintenance or replacement of the pump that is likely to fail. In some examples, the method can comprise ordering a part when a likely pump failure is identified. The scheduling and/ordering can be manually performed by a person or can be automatically performed by a controller, such as controller 120. The method can comprise a step of servicing or replacing at least one of the pumps when the comparison for the at least one pump is indicative that the at least one pump is likely to fail. In one example, the servicing can include lubricating gears of the pump. The method can comprise a step of modifying an operation of the application system when a comparison for at least one of the pumps is indicative of an approaching pump failure so as to reduce a likelihood of the at least one pump failing or extend a life of the pump until the pump can be maintenance or replaced. For example, the method can comprise a step of reducing a line speed or pump RPM when an approaching pump failure is identified.

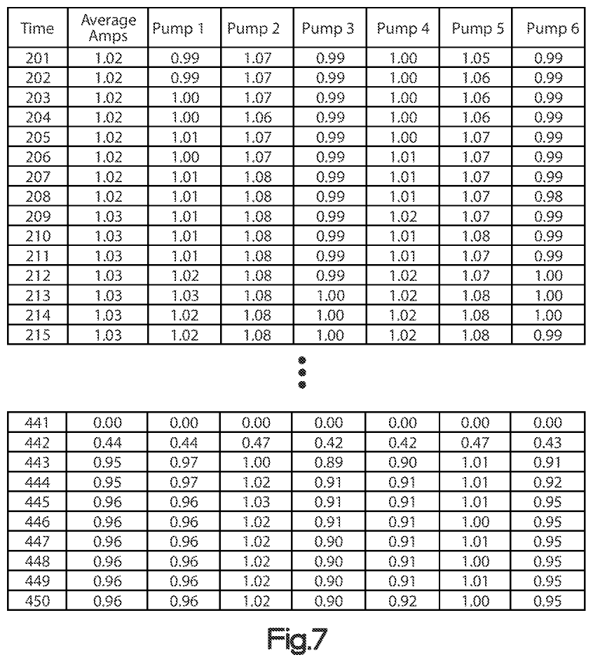

Referring to FIGS. 3 and 4, in step 206, the average electrical current for a particular time period can be determined by averaging the measures of the electrical current for the plurality of pumps at a particular time t. For example, the average can be proportional to:

$$\frac{{\sum }_{i = 1}^{N} measured {current}_{i} ( t )}{N} \qquad ( 1 )$$

wherein i is an index number for the pumps, N is the total number of pumps, and measured currentᵢ(t) is the measure of electrical current for pump i at time t. FIG. 7 shows a table of data generated during a simulation for an application system having six pumps for time periods 200 to 450. As shown, each row corresponds to a different time t, where the times are listed along the first column. The second column shows the average electrical current of the six pumps at each time t. The third to eighth columns show that measure of electrical current for the first to sixth pumps (i.e., i=1 to 6) respectively, at each time t.

This averaging step determines expected changes in pump current due to changes in load that all of the pumps experience. Commonly, these changes in load would be caused by changes in viscosity of the liquified material or changes in pump speed as commanded to meet changes in production line speed.

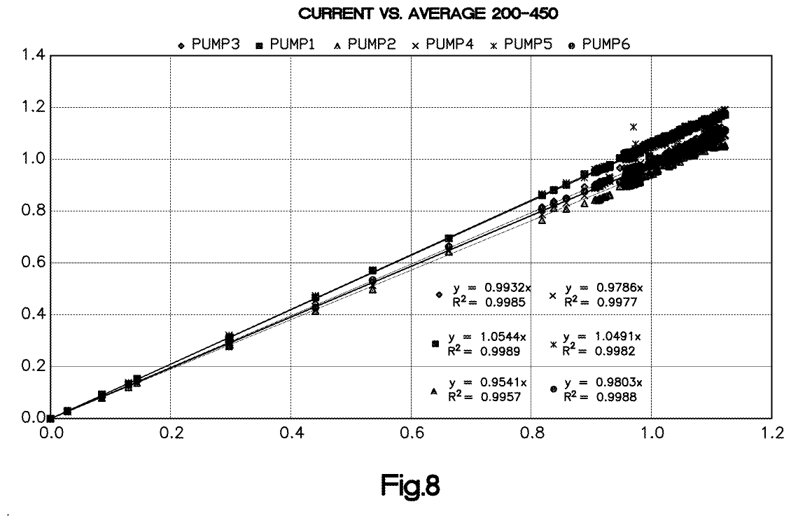

Upon generating an average electrical current for a particular time period, method 300 can be performed to implement step 208. The method 300 can comprise a step 302 of plotting, for each of the one or more of the plurality of pumps, the plurality of measures of electrical current for the pump at each period of time versus the plurality of average electrical currents at each period of time, and then mathematically fitting a line to the plot for each pump. It will be understood that, in some examples, step 302 can comprise fitting the line for each pump to the data mathematically, without first plotting the data. Each line can be fitted using a best-fit algorithm, such as a least squares regression method or any other suitable method. In some examples, each line can be fitted so as to force the y-intercept of the line to be zero. FIG. 8 shows an example plot generated for the six pumps in the simulation discussed above in relation to FIG. 7. In FIG. 8, the measured current is shown on the y-axis and the average current is shown on the x-axis, and each line corresponds to a different pump. Step 304 can comprise determining, for each of the one or more of the plurality of pumps, a slope of the fitted line for the pump. This step determines if the specific pump generally requires more or less current than the average pump, and quantifies how much for the prediction.

Step 305 comprises determining, for each of the one or more of the plurality of pumps, a predicted electrical current for the pump at the period of time based on the average electrical current for the period of time and the slope corresponding to the pump. For example, the step of determining, for each of the one or more of the plurality of pumps, the predicted electrical current for the pump can comprise multiplying the slope corresponding to the pump by the average electrical current for the pump at a given time period. Thus, the predicted electrical current for each pump at each period of time can be proportional to:

average current(t)×slopeᵢ (2)

where average current(t) is the average current of plurality of pumps at time t, i an index number of the pump, and slopeᵢ is the slope for pump i.

In step 306, the metric for each of the one or more of the plurality of pumps at each period of time can be generated by determining a difference between the predicted electrical current for the pump and the measure of electrical current drawn by the pump. For example, each metric can be proportional to:

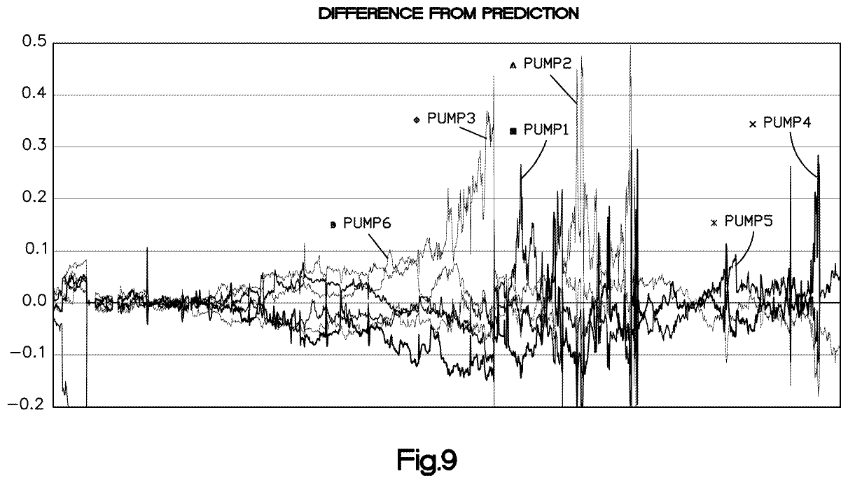

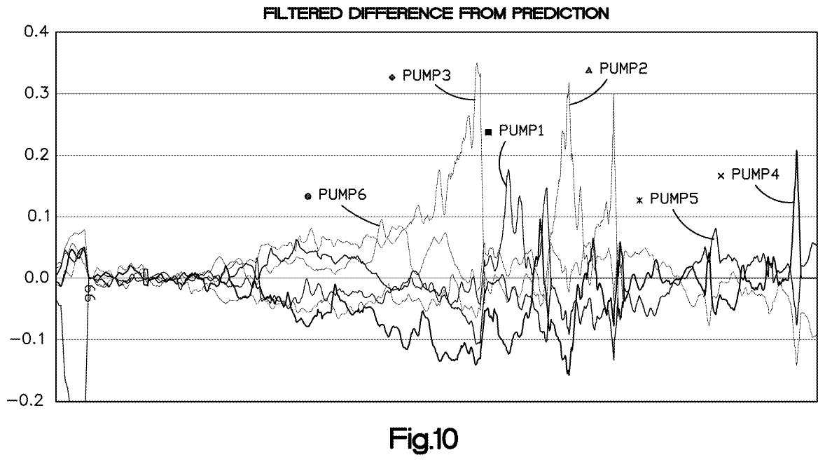

measured currentᵢ(t)−predicted currentᵢ(t) (3)

wherein i is an index number pump number, measured currentᵢ(t) is the measure of electrical current for pump i at time t, and predicted currentᵢ(t) is the predicted electrical current for pump i at time t. However, it will be understood that, in alternative examples, the metric can be calculated from the measured current and predicted current in another suitable matter. For example, the measured current can be subtracted from or divided by, the predicted current. FIG. 9 shows an example plot generated of metrics over time for the six pumps in the simulation discussed above in relation to FIG. 4. The metrics are shown on the y-axis and time is shown on the x-axis.

In some examples, each metric can optionally be filtered in step 308 before it is compared to the threshold in step 210 of FIG. 3. This filtering step helps eliminate false positive predictions based on a transient change. For example, the method 200 can optionally comprise, upon generating each metric, a step of filtering the metric. For instance, each filtered metric can be proportional to:

$$\frac{{\sum }_{t = x}^{z} {metric}_{i} ( t )}{Z} \qquad ( 4 )$$

wherein i is an index number of the pump, metricᵢ(t) is the metric for pump i at time t, and Z is a total number of the metrics used in the calculation. FIG. 10 shows an example plot generated of filtered metrics over time for the six pumps in the simulation discussed above in relation to FIG. 7. The filtered metrics are shown on the y-axis and time is shown on the x-axis. In FIG. 10, it can be seen that, when the pumps are operating properly, the metrics for each of the pumps are generally under 0.1. However, as a pump approaches a failure, the metrics for that pump raise above 0.1. Thus, in one example, the threshold can be set to 0.1 or approximately 0.1.

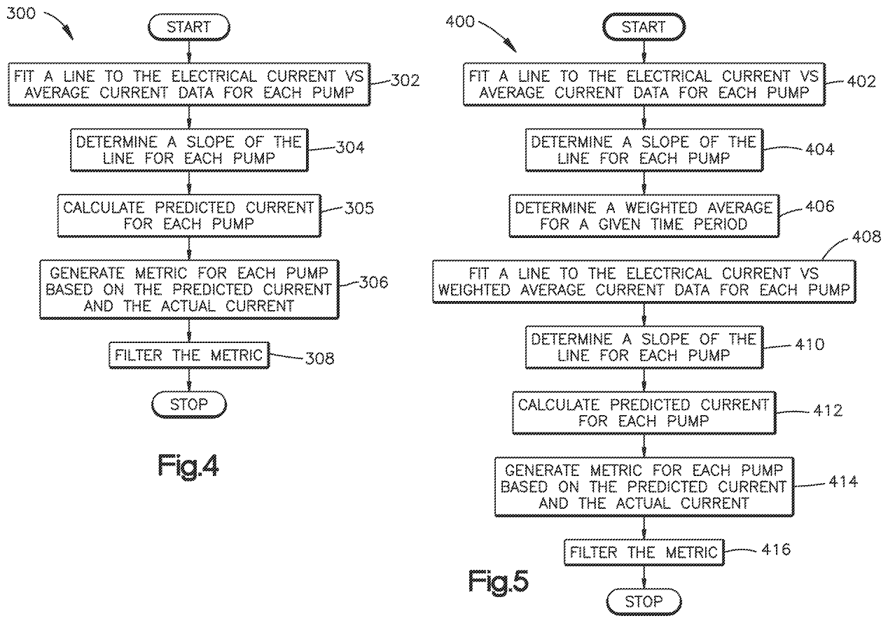

Turning to FIGS. 3 and 5, in step 206, the average electrical current for a particular time period can be determined as discussed above in relation to Equation (1). Upon generating an average electrical current for a particular time period, method 400 can be performed to implement step 208. Method 400 is implemented with a normalization technique, such as weighted averaging, which may be useful where the pumps of the system are different sizes, and consequently have different current draws. This weighted average helps normalize the data so that larger pumps do not bias the average relative to smaller pumps. Other normalization methods are known in the art and may be used in the context of this method. In method 400, steps 402 and 404 can be performed as discussed above in relation to steps 302 and 304.

In step 406, a weighted average is determined for a particular time period t. For example, the average can be proportional to:

$${\sum }_{i = 1}^{N} ( \frac{measured {current}_{i} ( t )}{{slope}_{i} \times N} ) \qquad ( 5 )$$

wherein i is an index number for the pumps, N is the total number of pumps, and measured currentᵢ(t) is the measure of electrical current for pump i at time t.

The method can comprise, in step 408, plotting, for each of the one or more of the plurality of pumps, the plurality of measures of electrical current for the pump at each period of time versus the plurality of weighted average electrical currents at each period of time, and then mathematically fitting a line to the plot for each pump. The plot would be similar to that discussed above in relation to FIG. 8, albeit using the weighted average electrical currents in lieu of using non-weighted average electrical currents. It will be understood that, in some examples, step 408 can comprise fitting the line for each pump to the data mathematically, without first plotting the data. Each line can be fitted using a best-fit algorithm, such as a least squares regression method or any other suitable method. In some examples, each line can be fitted so as to force the y-intercept of the line to be zero. Step 410 can comprise determining, for each of the one or more of the plurality of pumps, a slope of the fitted line for the pump.

The method can comprise, in step 412, determining, for each of the one or more of the plurality of pumps, a predicted electrical current for the pump at the period of time based on the average electrical current for the period of time and the slope corresponding to the pump. For example, the step of determining, for each of the one or more of the plurality of pumps, the predicted electrical current for the pump can comprise multiplying the slope corresponding to the pump by the weighted average electrical current for the pump at a given time period. Thus, the predicted electrical current for each pump at each period of time can be proportional to:

weighted average current(t)×slopeᵢ (6)

where weighted average current(t) is the weighted average current of plurality of pumps at time t, i an index number of the pump, and slope, is the slope for pump i.

The method can comprise, in step 414, generating the metric for each of the one or more of the plurality of pumps at each period of time by determining a difference between the predicted electrical current for the pump and the measure of electrical current drawn by the pump. The metric can be calculated as discussed above in relation to step 306. For example, each metric can be proportional to:

measured currentᵢ(t)−predicted currentᵢ(t) (7)

wherein i is an index number pump number, measured currentᵢ(t) is the measure of electrical current for pump i at time t, and predicted currentᵢ(t) is the predicted electrical current for pump i at time t. However, it will be understood that, in alternative examples, the metric can be calculated from the measured current and predicted current in another suitable matter. For example, the measured current can be subtracted from, or divided by, the predicted current.

In some examples, each metric can optionally be filtered in step 416 before it is compared to the threshold in step 210 of FIG. 3. Each metric can be filtered in a manner similar to that discussed above in relation to step 308.

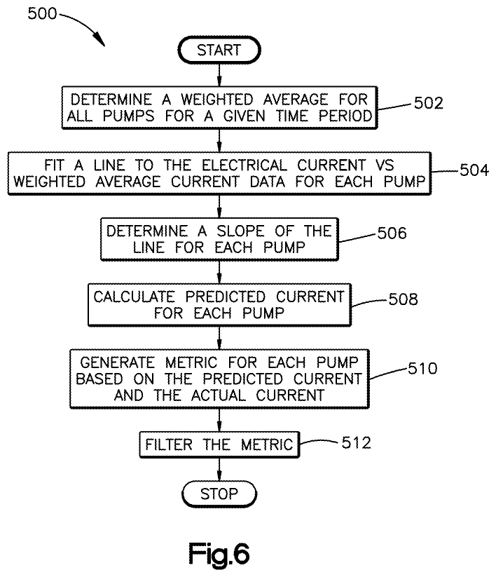

Turning now to FIGS. 3 and 6, another example of generating the metrics using a normalization technique, such as a weighted average, is discussed. In step 206, the average electrical current for a particular time period can be determined in an alternative manner than that discussed above in relation to Equation (1). In particular, the measures of electrical current over time for each pump can be averaged so as to generate an average electrical current for each pump (as opposed to an average for all pumps per time period). In other words, in the table of FIG. 7, a plurality of the electrical currents in each column can be averaged with one another so as to generate one average for each pump. In the example of FIG. 7, this would result in six total averages. Each average can be proportional to:

$$\frac{{\sum }_{t = x}^{x + Z} measured {current}_{i} ( t )}{Z} \qquad ( 8 )$$

wherein i is an index number for the pumps, measured currentᵢ(t) is the measure of electrical current for pump i at time t, and Z is equal to the number of time periods averaged for pump i.

Step 206 can further comprise determining an average of the averages for the pumps determined in step 206. Thus, in the examiner of FIG. 7, the six averages would be averaged to generate one average value. The average of the averages can be proportional to:

$$\frac{{\sum }_{i = 1}^{N} measured {current}_{i}}{N} \qquad ( 9 )$$

wherein the average currentᵢ is the average current for pump i, and N is the total number of pumps.

Upon generating the average of the average electrical currents in step 206, method 500 can be performed to implement step 208. Method 500 is implemented with weighted averaging, which may be useful where the pumps of the system are different sizes, and consequently have different current draws. Referring now more specifically to FIG. 6, the method 500 can comprise determining, in step 502, a weighted average for each particular time period t. For example, each average can be proportional to:

$${\sum }_{i = 1}^{N} ( \frac{measured {current}_{i} ( t ) \times M}{average {current}_{i} \times N} ) \qquad ( 10 )$$

wherein M is the average of the average currents determined as discussed above in relation to Equation (9), measured currentᵢ(t) is the measure of electrical current for pump i at time t, average currentᵢ is the average current for pump i determined as discussed above in relation to Equation (8), and N is the total number of pumps.

The method 500 can comprise a step 504 of fitting, for each of the one or more of the plurality of pumps, a line to a plot of the plurality of measures of electrical current for the pump at each period of time versus the plurality of weighted average electrical currents at each period of time. Step 504 can be performed in a manner similar to step 408 discussed above. The method 500 can comprise steps 506, 508, and 510 to generate a metric for each pump at a period of time. Steps 506, 508, and 510 can be performed in a manner similar to that discussed above in relation to steps 410, 412, and 414. In some examples, each metric can optionally be filtered in step 512 before it is compared to the threshold in step 210 of FIG. 3. Each metric can be filtered in a manner similar to that discussed above in relation to step 308.

It will be understood that various embodiments of the present invention can include a non-transitory, computer-readable storage medium storing instructions thereon that, when executed by a computer, cause the computer to perform steps of the method or methods described herein.

It should be noted that the illustrations and descriptions of the examples shown in the figures are for exemplary purposes only, and should not be construed limiting the disclosure. One skilled in the art will appreciate that the present disclosure contemplates various examples. Additionally, it should be understood that the concepts described above with the above-described examples may be employed alone or in combination with any of the other examples described above. It should further be appreciated that the various alternative examples described above with respect to one illustrated example can apply to all examples as described herein, unless otherwise indicated.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more examples or that one or more examples necessarily include these features, elements and/or steps. The terms “comprising,” “including,” “having,” and the like are synonymous and are used inclusively, in an open-ended fashion, and do not exclude additional elements, features, acts, operations, and so forth.

While certain examples have been described, these examples have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

It will be understood that reference herein to “a” or “one” to describe a feature such as a component or step does not foreclose additional features or multiples of the feature. For instance, reference to a device having or defining “one” of a feature does not preclude the device from having or defining more than one of the feature, as long as the device has or defines at least one of the feature. Similarly, reference herein to “one of” a plurality of features does not foreclose the invention from including two or more, up to all, of the features. For instance, reference to a device having or defining “one of a X and Y” does not foreclose the device from having both the X and Y.

1. A method of operating an application system that is configured to apply a liquified material to a substrate, the method comprising:
operating a plurality of pumps of the application system to supply a liquified material from a material supply system of the application system to a plurality of dispensers of the application system;
receiving, for the plurality of pumps, measures of electrical current drawn by the pumps;
determining an average electrical current for the plurality of pumps by averaging the measures of the electrical current; and
generating, for each of one or more of the plurality of pumps, a metric based on the average current, wherein the metric is indicative of how soon the pump is likely to fail.

2. The method of claim 1, wherein the generating step comprises:
determining, for each of the one or more of the plurality of pumps, a predicted electrical current drawn by the pump based on the average electrical current; and
determining, for each of the one or more of the plurality of pumps, the metric based on the predicted electrical current for the pump and the measure of electrical current drawn by the pump.

3. The method of claim 2, wherein the step of determining the metric for each of the one or more of the plurality of pumps comprises determining a difference between the predicted electrical current for the pump and the measure of electrical current drawn by the pump.

4. The method of claim 2, comprising, for each of the one or more of the plurality of pumps, a step of filtering the metric.

5. The method of claim 1, wherein:
the receiving step comprises receiving, for each of the plurality of pumps, a plurality of measures of electrical current drawn by the pump, each corresponding to a different period of time;
the determining step comprises determining, for each period of time, an average electrical current for the plurality of pumps by averaging the measures of electrical current for the plurality of pumps for the period of time; and
the generating step comprises generating, for each of the one or more of the plurality of pumps, a metric for each period of time based on the average electrical current corresponding to the period of time, wherein each metric is indicative of soon the pump is likely to fail.

6. The method of claim 5, wherein the average electrical current for the plurality of pumps at each time is proportional to:
$$\frac{{\sum }_{i = 1}^{N} measured {current}_{i} ( t )}{N} ,$$
wherein:
i is an index number for the pump;
N is a total number of pumps; and
measured currentᵢ(t) is the measure of electrical current for pump i at time t.

7. The method of claim 5, wherein the generating step comprises:
fitting, for each of the one or more of the plurality of pumps, a line to the plurality of measures of electrical current for the pump and the plurality of average electrical currents;
determining, for each of the one or more of the plurality of pumps, a slope of the line; and
determining, for each of the one or more of the plurality of pumps and each of the periods of time, a predicted electrical current for the pump at the period of time based on the average electrical current for the period of time and the slope corresponding to the pump.

8. The method of claim 7, wherein the step of determining, for each of the one or more of the plurality of pumps, the predicted electrical current for the pump comprises multiplying the slope corresponding to the pump by the average electrical current for the pump.

9. The method of claim 7, wherein the predicted electrical current for each pump at each period of time is proportional to:
average current(t)×slopeᵢ, wherein:
average current(t) is the average current of plurality of pumps at time t;
i an index number of the pump; and
slopeᵢ is the slope for pump i.

10. The method of claim 7, wherein the fitting step comprises fitting, for each of the one or more of the plurality of pumps, a line to the plurality of measures of electrical current drawn by the pump and the average measures of electrical current drawn by the plurality of pumps using a least squares regression method.

11. The method of claim 7, wherein the step of generating the metric for each pump and for each time period comprises taking a difference between the measured current for the pump at the time period and the predicted current for the pump at the time period.

12. The method of claim 7, wherein the metric for each pump at each period of time is proportional to:
measured currentᵢ(t)−predicted currentᵢ(t), wherein:
i is an index number pump number;
measured currentᵢ(t) is the measure of electrical current for pump i at time t; and
predicted currentᵢ(t) is the predicted electrical current for pump i at time t.

13. (canceled)

14. The method of claim 1, comprising a step of comparing the metric for each of one or more of the plurality of pumps to a threshold to determine how soon the pump is likely to fail.

15. (canceled)

16. The method of claim 14, comprising a step of generating, based on the comparison, a notification to a user regarding when at least one pump is likely to fail.

17. (canceled)

18. The method of claim 1, comprising a step of modifying an operation of the application system when a comparison for at least one of the pumps is indicative of an approaching pump failure so as to reduce a likelihood of the at least one pump failing.

19. The method of claim 14, comprising a step of transmitting, based on the comparison, a signal that is indicative of a need for servicing at least one of the pumps or that schedules service for at least one of the pumps.

20-21. (canceled)

22. The method of claim 14, comprising:
storing, for each of the plurality of pumps, information related to an operational time of the pump when a likely failure of the pump is predicted in the comparing step; and
predicting a failure of one or more other pumps of (i) the application system, (ii) one or more other application systems, or (iii) the application system and one or more other application systems, based on the stored information.

23. (canceled)

24. The method of claim 22, wherein the stored information comprises a total number of revolutions of a pump shaft of the pump from startup of the pump until the predicted failure.

25. An application system configured to apply a liquified material to a substrate, the application system comprising:
a material supply system configured to supply the liquified material;
a plurality of dispensers configured to receive the liquified material and dispense the liquified material onto a substrate;
a plurality of pumps in fluid communication with the material supply system and configured to pump the liquified material to the plurality of dispensers; and
a controller configured to:
receive, for the plurality of pumps, measures of electrical current drawn by the pumps;
determine an average electrical current by averaging the measures of the electrical current; and
generate, for each of one or more of the plurality of pumps, a metric based on the average current, wherein the metric is indicative of how soon the pump is likely to fail.

26. The application system of claim 25, wherein the plurality of pumps comprises two or more pumps, each being in fluid communication with a different set of one or more of the dispensers such that each of the two or more pumps is configured to pump the liquified material to a different set of one or more of the dispensers.

27-29. (canceled)

30. The application system of claim 25, wherein the controller is configured to:
determine, for each of the one or more of the plurality of pumps, a predicted electrical current drawn by the pump based on the average electrical current; and
determine the metric for each of the one or more of the plurality of pumps based on the predicted electrical current for the pump and the measure of electrical current drawn by the pump.

31. (canceled)

32. The application system of claim 30, wherein the controller is configured to filter the metric for each of the one or more of the plurality of pumps.

33. The application system of claim 25, wherein the controller is configured to:
receive, for each of the plurality of pumps, a plurality of measures of electrical current drawn by the pump, each corresponding to a different period of time;
determine, for each period of time, an average electrical current for the plurality of pumps by averaging the measures of electrical current for the plurality of pumps for the period of time; and
generate, for each of the one or more of the plurality of pumps, a metric for each period of time based on the average electrical current corresponding to the period of time, wherein each metric is indicative of how soon the pump is likely to fail.

34. The application system of claim 33, wherein the average electrical current for the plurality of pumps at each time is proportional to:
Σᵢ₌₁ⁿ measured currentᵢ(t), wherein:
i is an index number for the pump;
n is the total number of pumps; and
measured currentᵢ(t) is the measure of electrical current for pump i at time t.

35. The application system of claim 33, wherein the controller is configured to generate the metric for each of the pumps and each of the periods of time by:
fitting, for each of the one or more of the plurality of pumps, a line to the plurality of measures of electrical current for the pump and the plurality of average electrical currents;
determining, for each of the one or more of the plurality of pumps, a slope of the line; and
determining, for each of the one or more of the plurality of pumps and each of the periods of time, a predicted electrical current for the pump at the period of time based on the average electrical current for the period of time and the slope corresponding to the pump.

36. (canceled)

37. The application system of claim 35, wherein the predicted electrical current for each pump at each period of time is proportional to:
average current(t)×slopeᵢ, wherein:
average current(t) is the average current of plurality of pumps at time t;
i an index number of the pump; and
slopeᵢ is the slope for pump i.

38. (canceled)

39. The application system of claim 35, wherein the controller is configured to generate the metric for each pump and for each time period by taking a difference between the measured current for the pump at the time period and the predicted current for the pump at the time period.

40. The application system of claim 35, wherein the metric for each pump at each period of time is proportional to:
measured currentᵢ(t)−predicted currentᵢ(t), wherein:
i is an index number pump number;
measured currentᵢ(t) is the measure of electrical current for pump i at time t; and
predicted currentᵢ(t) is the predicted electrical current for pump i at time t.

41. The application system of claim 35, comprising a step of filtering each metric, wherein each filtered metric is proportional to:
$$\frac{{\sum }_{t = x}^{Z} {metric}_{i} ( t )}{Z} ,$$
wherein:
i is an index number of the pump;
metricᵢ(t) is the metric for pump i at time t; and
Z is a total number of the metrics used in the calculation.

42-43. (canceled)

44. The application system of claim 25, wherein the controller is configured to schedule maintenance or replacement of a pump based on a comparison of the metric for each of one or more of the plurality of pumps to a threshold.

45. The application system of claim 25, wherein the controller is configured to modify an operation of the application system when a comparison for at least one of the pumps is indicative of an approaching pump failure so as to reduce a likelihood of the at least one pump failing.

46. (canceled)

47. A non-transitory, computer-readable storage medium storing instructions thereon that, when executed by a computer, cause the computer to:
receive, for each of a plurality of pumps of an application system, a measure of electrical current drawn by the pump, while the plurality of pumps supply a liquified material from a material supply system of the application system to a plurality of dispensers of the application system;
determine an average electrical current for the plurality of pumps by averaging the measures of the electrical current drawn by the plurality of pumps; and
generate, for each of one or more of the plurality of pumps, a metric based on the average current, wherein the metric is indicative of how soon the pump is likely to fail.
